(19) United States
(12) Patent Application Publication
(10) Pub. No.: US 2014/0159521 A1
(43) Pub. Date: Jun. 12, 2014

(54) METHOD AND APPARATUS FOR REDUCING NOISE OR ELECTROMAGNETIC INTERFERENCES IN A ROTATORY DEVICE

(71) Applicant: Johnson Electric S.A., Murten (CH)

(72) Inventors: Tongjie LI, Shenzhen (CN); Qingbin LUO, Shenzhen (CN); Guowei SUN, Shenzhen (CN); Ying CHEN, Shenzhen (CN); Huiting ZHONG, Shenzhen (CN)

(73) Assignee: Johnson Electric S.A., Murten (CH)

(21) Appl. No.: 13/956,215

(22) Filed: Jul. 31, 2013

(30) Foreign Application Priority Data
Jul. 31, 2012 (CN) 201210271268.X

(51) Int. Cl. H02K 13/00; H02K 11/02

(52) U.S. Cl. CPC H02K 13/006; H02K 11/02
USPC 310/72; 310/233

(57) ABSTRACT

An apparatus includes multiple brushes (30, 30B, 30A, 30a, 30b) and a commutator (10) that has multiple commutator plates (12, 12A, 12B, 13B) to contact the multiple brushes for commutation in order to convert electrical energy into mechanical energy or vice versa. A brush may include an EMI suppression mechanism (30, 38A, 38B) to reduce random electromagnetic interferences or a filter circuitry (400B) to reduce the overall level of electromagnetic interferences. An EMI suppression mechanism may include a specially designed brush that leverages dielectric properties or mechanical properties of the brush to reduce electromagnetic interferences. An EMI suppression filter circuitry may include an all-capacitor filter circuitry that does not include beads or chokes.

### CROSS REFERENCE TO RELATED APPLICATION(S)

This application claims the benefit of Chinese patent application serial no. 201210271268.X having a filing date of Jul. 31, 2012. The entire content of the aforementioned patent applications is hereby incorporated by reference for all purposes.

### BACKGROUND

In an electric motor, the moving part is the rotor which turns the output shaft of the motor to deliver the mechanical power. In a brushed motor, the rotor usually has conductors which carry electrical currents that interact with the magnetic field of the stator to generate the forces or torques that turn the output shaft. The stator usually includes either windings or permanent magnets. Windings are wires that are laid in coils, usually wrapped around a core (e.g., a laminated soft iron magnetic core) in order to form magnetic poles when energized with electrical current. A commutator includes a mechanism rotating with the motor output shaft for switching the input of certain AC or DC systems including slip ring segments or commutator plates (collectively “commutator plates” or “commutator plate”) that are insulated from each other.

A brushed DC motor is an internally commutated electric motor designed to be run from a direct current power source. A brush is a device which conducts current between stationary wires and moving parts, most commonly the rotor. A commutator is the moving part of a rotary electrical switch in certain types of electric motors or electrical generators that periodically reverses the current direction between the rotor and the external circuit. A commutator is a common feature of direct current rotating machines. A motor produces a rotating force or torque by reversing the current direction in the moving coil of a motor's armature. Similarly, a generator provides direct current to an external circuit by reversing the coil's connection to the external circuit.

A brushed motor or a generator exhibits several short-comings such as causing a short during commutation when a brush contacts more than one commutator plate, unstable or less-than-desired electrical contact between a brush and a commutator plate to conduct electrical current due to vibrations or traversal of the brush across a gap between two adjacent commutator plates, or electromagnetic interferences from various sources. The vibrations, electronic noise, electromagnetic interferences, or the short may cause variations in, for example, electrical conductance which may in turn affect, for example, several characteristics of the rotatory device.

Therefore, there exists a need for an improved motor or generator.

### SUMMARY

Various embodiments are directed at a rotatory device that is to convert electrical energy (e.g., electrical current) into mechanical energy (e.g., mechanical, rotational force or torque) or vice versa. An exemplary rotatory device may include multiple brushes and a commutator that has multiple commutator plates to contact the multiple brushes for commutation in order to convert electrical energy into mechanical energy or vice versa. A brush may include an EMI suppression mechanism to reduce, suppress, or filter out a first portion of electromagnetic interferences in some embodiments. In these embodiments, an EMI suppression mechanism may include a specially designed brush that leverages dielectric properties (e.g., resistivity, dielectric strength, etc.) or mechanical properties of the brush (e.g., the geometric shape based on thin shell theory under, for example, the Kirchhoff-Love theory of thin plates, the stress-strength relationship(s) of material(s), yield strength(s) of material(s), etc.) to reduce electromagnetic interferences. In addition or in the alternative, a brush may include a filter circuitry to reduce a second portion of electromagnetic interferences in some embodiments. An exemplary filter circuitry may include an all-capacitor filter circuitry in some embodiments. In some of these embodiments, the filter circuitry does not include any beads or chokes to reduce, suppress, or filter out electromagnetic interferences.

Moreover, rotatory devices as described in this application may include, for example but not limited to, a brushed motor or an electricity generator that includes a commutator and brushes. In some of the embodiments, the commutator includes a plurality of commutator plates or elements (collectively plates or plate) arranged in an angular direction, and the brushes are made of electrically conductive materials. In some embodiments, a brush comprises a geometric shape that is resilient so as to withstand shock or loading without substantially permanent deformation or rupture. It shall be noted that substantial permanent deformation occurs when a brush loses its original shape to an extent that the brush is no longer capable of perform its intended functions of conducting electrical currents between stationary wires and moving parts (e.g., the commutator plates). In some embodiments, a brush comprises a geometric shape that is elastic so as to recover its original shape or size after deformation due to, for example, shock or loading. A brush includes a first end that to which leads or wires are fixedly attached and a second end that is used to contact the commutator plates.

In some embodiments, the rotatory device includes an EMI (electromagnetic interference) suppression mechanism that is operatively connected to or is an inseparable part of the second end of a brush. In some of these embodiments, the EMI suppression mechanism or the second end of a brush comprises an arcuate, curved, or serpentine (hereinafter curved collectively) segment that bends or curves in a direction away from the commutator plates. In some embodiments, the EMI suppression mechanism comprises a material with high resistivity. At least a part of the second end of the brush contacts the commutator plates and is hereby referred to as a contact region or a commutation region (hereinafter commutation region) of the brush in some embodiments. In some of these embodiments, the EMI suppression mechanism including a material of high resistivity is distributed in the area or vicinity around or near the commutation region.

Some embodiments are directed at a rotatory device including a filter circuitry. In some of these embodiments, the filter circuitry includes one or more grounded capacitors, decoupling capacitors, snubber capacitors, or bypass capacitors (hereinafter decoupling capacitors or decoupling capacitor). In these embodiments, noise caused by one or more circuit elements (e.g., the brushes or other circuit elements) is shunted through the one or more decoupling capacitors so as to reduce its effects.

In some of these embodiments, a decoupling capacitor creates a circuit path for an impulse that is generated by the voltage drop across the open circuit due to the quick drop of the electrical current when the circuit is opened to bypass the contacts (e.g., when the brushes disengage the commutator in a brushed motor or generator.) in some of these embodiments, a snubber capacitor may be operatively connected to a resistor in series to reduce electromagnetic interference or radio-frequency interference (hereinafter EMI) or to dissipate energy. In some of these embodiments, the capacitor-resistor combination is a single package including a decoupling capacitor element and a resistor element.

In some embodiments, noise is a summation of unwanted or disturbing energy from natural and sometimes artificially introduced sources (e.g., commutation in a brushed motor or generator due to the existence of a gap between two adjacent commutator plate, conductance fluctuations due to variations in contacts between the brushes and the commutator plates, etc.) Electromagnetic interference refers to, on the other hand, jamming, cross-talk, cross-coupling, capacitive coupling, or other undesired radio-frequency interferences from specific transmitter(s) or source(s) in some embodiments. Nonetheless, the terms “noise” and “electromagnetic interference” may be used interchangeably throughout this application, unless otherwise specifically claimed or recited.

Some embodiments are directed at a rotatory device that includes a commutator and brushes. In some of these embodiments, the commutator comprises multiple commutator plates, each having a three-dimensional shape having at least one convex surface to facilitate the contact between the commutator plates and the brushes. In some of these embodiments, the commutator comprises multiple commutator plates, each having a three-dimensional shape having at least one flat surface to facilitate the contact between the commutator plates and the brushes. In some embodiments, the commutator comprises multiple commutator plates, each having a section along the lengthwise direction of a substantially right or oblique cylindrical shape. In some of these embodiments, the “convex” surface or the substantially cylindrical surface may be used to directly contact the brushes to conduct electrical currents.

It shall be noted that the term “substantially” or “substantial” such as in the “substantially cylindrical shape” is used herein to indicate that certain features, although designed or intended to be perfect (e.g., perfectly cylindrical), the fabrication or manufacturing tolerances, the slacks in various mating components or assemblies due to design tolerances or normal wear and tear, or any combinations thereof may nonetheless cause some deviations from this designed, perfect characteristic. Therefore, one of ordinary skill in the art will clearly understand that the term “substantially” or “substantial” is used here to incorporate at least such fabrication and manufacturing tolerances, the slacks in various mating components or assemblies, or any combinations thereof. In some embodiments, a commutator includes multiple commutator plates which may be arranged in an angular arrangement along the outer edge of the commutator. In some of these embodiments, these multiple commutator plates may be arranged in an axis-symmetric manner with respect to the center of the commutator.

A brush may comprise one or more features that may be made of one or more materials comprising a resilient material to withstand shock or loading without substantially permanent deformation or rupture, an elastic material to recover its original shape or size after deformation due to, for example, shock or loading, or any other materials whose deformations under loading according to the stress-strain or stress-deformation relations or the resilience of the materials is at least somewhat reversible such that a sufficiently high contact stress or sufficiently low contact resistance between a brush and a commutator plate may be effected or maintained without generating an excessive amount of heat that exceeds a predetermined threshold (e.g., a temperature range or limit) due to poor electrical contacts. In these embodiments, the brush remains flexible although the brush does not necessarily restore to its original shape or profile once the loading is removed yet produces sufficiently high contact stress or sufficiently low contact resistance when in contact with a commutator plate.

In addition or in the alternative, a brush includes a first end that to which leads or wires are fixedly attached and a second end that is used to contact the commutator plates. In some embodiments, a brush includes one or more finger elements that are used to make electrical contact with the commutator plates with sufficiently contact stress or sufficiently low resistance such that the electrical contact between a brush and a commutator plate does not generate an amount of heat that exceeds a predetermined amount. In some embodiments, the finger element of a brush includes a high resistivity element such that the brush does not cause short by electrically contacting more than one commutator plate when the brush is passing through a gap between two adjacent commutator plates during operations of the rotatory device. In some of these embodiments, the finger element of a brush comprises a resilient, elastic, or flexible shape or material to maintain electrical contact with the commutator plates such that that the brush does not cause short even when the rotatory device, the commutator, or the finger element is subject to some vibrations from various sources.

In some embodiments, the rotatory device includes an EMI (electromagnetic interference) suppression mechanism that is operatively connected to or is an inseparable part of the second end of a brush. In some embodiments, the EMI suppression mechanism comprises an arcuate, curved, or serpentine segment that bends in a direction away from the commutator plates. In some of these embodiments, the EMI suppression mechanism comprises a material with high resistivity. In some of these embodiments, the EMI suppression mechanism including a material of high resistivity is distributed in the area or vicinity around or near the commutation region, and the resistivity of the material for the EMI suppression mechanism is higher than that of at least the commutation region of a brush.

In some embodiments, the EMI suppression mechanism comprises an arcuate, curved, or serpentine segment that bends in a direction away from the commutator plates. In some embodiments, the rotatory device includes a filter circuitry. In some of these embodiments, the filter circuitry contains one or more capacitors and one or more interconnects. In one embodiment, the filter circuitry includes one or more grounded capacitors. In some of these embodiments, each commutator plate is electrically connected to at least two grounded capacitors, which are connected in parallel and are further connected to the ground. In the aforementioned embodiments, the rotatory device is effectively protected from various noise (e.g., Gaussian noise, drift noise, shot noise, any combinations thereof, etc.) or electromagnetic interferences from various sources such that the frequency-based noise (e.g., various colors of noise) or non-frequency based noise (e.g., pops, crackles, snaps, etc.) may be suppressed or reduced. In one embodiment, the rotatory device or rotatory assembly does not include any ferrite bead, which comprises a passive electric component often used to suppress high or higher frequency noise in electronic circuits by dissipating high frequency currents in a ferrite ceramic. It shall be noted that unless otherwise specifically claimed or recited, a ferrite bead is used interchangeably with a block, a core, an EMI filter, or a choke, all of which comprise some passive electronic component to block high or higher frequency current in an electrical circuit, while allowing low or lower frequency or DC current to pass.

More details about the improved impeller are described in the Detailed Description section with reference to FIGS. 1-6 as provided below.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 illustrates a simplified schematic diagram of an exemplary rotatory device in some embodiments.

FIG. 2A illustrates a plan schematic view of interrelation between brushes and a commutator of an exemplary rotatory device at one point in time in some embodiments.

FIG. 2B illustrates more details about the plan schematic view of interrelation between brushes and a commutator of an exemplary rotatory device illustrated in FIG. 2A at another point in time in some embodiments.

FIG. 3A illustrates a plan schematic view of interrelation between brushes and a commutator of an exemplary rotatory device at one point in time in some embodiments.

FIG. 3B illustrates a plan schematic view of a brush of an exemplary rotatory device at one point in time in some embodiments.

FIG. 4A illustrates a schematic of benchmark filter circuitry in some embodiments.

FIG. 4B illustrates a schematic of an exemplary filter circuitry in some embodiments.

FIG. 5A illustrates a benchmark electronic noise profile with respect to frequencies of an exemplary rotatory device in some embodiments.

FIG. 5B illustrates an improved electronic noise profile with respect to frequencies of an exemplary rotatory device in some embodiments.

FIGS. 6A-C illustrate electronic noise profiles with respect to frequencies (MHz) for one or more exemplary rotatory devices in some embodiments.

### DETAILED DESCRIPTION

Various features are described hereinafter with reference to the figures. It shall be noted that the figures are not necessarily drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

One aspect or an advantage described in conjunction with a particular embodiment is not necessarily limited to that embodiment and may be practiced in any other embodiments, even if not so illustrated, or if not explicitly described. Also, reference throughout this specification to “some embodiments” or “other embodiments” means that a particular feature, structure, material, process, or characteristic described in connection with the embodiments is included in at least one embodiment. Thus, the appearances of the phrase “in some embodiments”, “in one or more embodiments”, or “in other embodiments” in various places throughout this specification are not necessarily referring to the same embodiment or embodiments.

Various embodiments are directed at a rotatory device that is to convert electrical energy (e.g., electrical current) into mechanical energy (e.g., mechanical, rotational force or torque) or vice versa. The rotatory device may include, for example but not limited to, a brushed motor, which converts electrical energy into mechanical, rotatory energy, or an electricity generator, which converts mechanical energy into electrical energy (e.g., electrical potential, electromotive force, etc.), that includes a commutator and brushes. In some of the embodiments, the commutator includes a plurality of commutator plates or elements (collectively plates or plate) arranged in an angular direction, and each of the brushes comprises one or more features made of one or more electrically conductive materials.

In some embodiments, a brush comprises a geometric shape that is resilient so as to withstand shock or loading without substantially permanent deformation or rupture. It shall be noted that substantial permanent deformation occurs when a brush loses its original shape to an extent that the brush is no longer capable of perform its intended functions of conducting electrical currents between leads or wires and moving parts (e.g., the commutator plates). In some embodiments, a brush comprises a geometric shape that is elastic so as to recover its original shape or size after deformation due to, for example, shock or loading. A brush includes a first end that to which leads or wires are fixedly attached and a second end that is used to contact the commutator plates in various embodiments.

In some embodiments, the second end of a brush is in sliding contact with the commutator plates in the sense that the second end of the brush remains substantially stationary in space while each commutator plate rotates or spins with the rotor to contact at least a part of the second end to facilitate a sufficient level of electrical contact (e.g., sufficiently high contact stress or sufficiently low contact resistance) between the second end of the brush and a commutator plate within a period of time during commutation. Thus, the second end of the brush appears as if it were sliding on at least a part of each commutator plate although it is the commutator part that is actually rotating or spinning. It shall be noted that the aforementioned description for the second end of the brush to remain substantially stationary in space indicate that the second end is not designed to actively exhibit motion when the second end is electrically connected to a commutator plate for conducting electricity. Nonetheless, such a description does not preclude that the second end of a brush may exhibit some motion due to, for example vibrations. In addition, such a description does not preclude that the second end of a brush may nevertheless exhibit some motion when the second end of a brush traverses across a gap between two adjacent commutator plates.

In some embodiments, the rotatory device includes an EMI (electromagnetic interference) suppression mechanism or feature (collectively EMI suppression mechanism) that is operatively connected to or is an inseparable part of the second end of a brush. For example, the EMI suppression mechanism may be formed together with the second end of a brush of which the EMI suppression mechanism is an integral feature by, for example but not limited to, pressing, bending, or machining, etc. with or without the heating process and the quenching process in some embodiments. In some other embodiments, the EMI suppression mechanism may be separately attached to the second end of a brush by, for example but not limited to, any appropriate processes for joining two components together including welding, mechanical means, brazing, spraying, powder coating, sintering, co-sintering, gluing, diffusion bonding, etc.

In some of these embodiments, the EMI suppression mechanism or a second end of a brush comprises an arcuate, curved, or serpentine segment that bends or curves in a direction away from the commutator plates. In addition or in the alternative, the EMI suppression mechanism of a brush may be configured or designed in such a way such that the contact stress between the EMI suppression mechanism and the corresponding commutator plate is at or exceeds a certain level of stress to ensure sufficient electrical contact between the EMI suppression mechanism and the commutator plate. For example, an EMI suppression mechanism may be designed based at least in part upon the design of the brush to which the EMI suppression mechanism is attached or the design of the commutator plates, etc. such that the contact stress is at or above the yield stress of the weaker (the component with lower yield stress) of the EMI suppression mechanism and the commutator plate in some embodiments.

In some embodiments, the EMI suppression mechanism comprises a material with high resistivity. In these embodiments, the EMI suppression mechanism is configured or designed in such a manner so as to prevent bridging multiple commutators during commutation when the commutator rotates or spins. At least a part of the second end of a brush or an EMI suppression mechanism contacts the commutator plates and is hereby referred to as a contact region or a commutation region (hereinafter commutation region) of the brush in some embodiments. In some of these embodiments, the EMI suppression mechanism including a material of high resistivity and is distributed in the area or vicinity around or near the commutation region of the brush or the EMI suppression mechanism.

Some embodiments are directed at a rotatory device that includes a filter circuitry to further suppress or reduce various sources of electronic noises. In some of these embodiments, the filter circuitry includes one or more grounded capacitors, decoupling capacitors, snubber capacitors, or bypass capacitors (hereinafter decoupling capacitors or decoupling capacitor collectively). In these embodiments, noise caused by one or more circuit elements or other sources (e.g., the brushes or other circuit elements) may be shunted through the one or more decoupling capacitors so as to reduce the effects of the noise. In some of these embodiments, a decoupling capacitor creates a circuit path for an impulse that is generated by the voltage drop across the open circuit due to the quick drop of the electrical current when the circuit is opened to bypass the contacts (e.g., when the brushes disengage the commutator in a brushed motor or generator.) in some of these embodiments, a snubber capacitor may be operatively connected to a resistor in series to reduce electromagnetic interference or radio-frequency interference (hereinafter EMI) or to dissipate energy.

In some of these embodiments, the capacitor-resistor combination contains a single package or component including both a decoupling capacitor element and a resistor element. In some embodiments, noise may comprise a summation of two or more forms of unwanted or disturbing energy from natural or artificially introduced sources (e.g., commutation in a brushed motor or generator due to the existence of a gap between two adjacent commutator plate, conductance fluctuations due to variations in contacts between the brushes and the commutator plates, etc.) In some embodiments, electromagnetic interference refers to, on the other hand, jamming, cross-talk, cross-coupling, capacitive coupling, or other undesired radio-frequency interferences from specific transmitter(s) or source(s) in some embodiments. Nonetheless, the terms “noise” and “electromagnetic interference” may be used interchangeably throughout this application, unless otherwise specifically claimed or recited.

Some embodiments are directed at a rotatory device that includes a commutator and brushes. In some of these embodiments, the commutator comprises multiple commutator plates, each having a three-dimensional shape having at least one convex surface for contacting the brush or a part thereof. In some embodiments, the commutator comprises multiple commutator plates, each having a smaller section that is formed along the lengthwise direction of a substantially right or oblique cylindrical shape. In some of these embodiments, the “convex” surface or the substantially cylindrical surface may be used to directly contact a brush or a part thereof to conduct electrical currents. It shall be noted that the term “substantially” or “substantial” such as in the “substantially cylindrical shape” is used herein to indicate that certain features, although designed or intended to be perfect (e.g., perfectly cylindrical), the fabrication or manufacturing tolerances, the slacks in various mating components or assemblies due to design tolerances or normal wear and tear, or any combinations thereof may nonetheless cause some deviations from this designed, perfect characteristic. Therefore, one of ordinary skill in the art will clearly understand that the term “substantially” or “substantial” is used here to incorporate at least such fabrication and manufacturing tolerances, the slacks in various mating components or assemblies, or any combinations thereof.

In some embodiments, a commutator includes multiple commutator plates which may be arranged in an angular arrangement along the outer edge of the commutator. In some of these embodiments, these multiple commutator plates may be arranged in an axis-symmetric manner with respect to the center of the commutator. A brush may be made of a material that comprises a resilient material to withstand shock or loading without substantially permanent deformation or rupture, an elastic material to recover its original shape or size after deformation due to, for example, shock or loading, or any other materials whose deformations under loading is at least somewhat reversible such that the brush may maintain sufficient contact stress against the commutator plates without generating an excessive amount of heat that exceeds a predetermined threshold due to poor electrical contacts. In these embodiments, the brush remains flexible although the brush does not necessarily restore to its original shape or profile once the loading is removed.

In addition or in the alternative, a brush includes a first end that to which leads or wires are fixedly attached and a second end that is used to contact the commutator plates. In some embodiments, a brush includes one or more finger element that is used to make electrical contact with the commutator plates with sufficiently contact stress or sufficiently low resistance such that the electrical contact between a brush and a commutator plate does not generate an amount of heat that exceeds a predetermined amount. In some embodiments, the finger element of a brush includes a high resistivity element such that the brush does not cause short by electrically contacting more than one commutator plate when the brush is passing through a gap between two adjacent commutator plates during operations of the rotatory device. In some of these embodiments, the finger element of a brush comprises a resilient, elastic, or flexible shape or material to maintain electrical contact with the commutator plates such that that the brush does not cause short even when the rotatory device, the commutator, or the figure element is subject to some vibrations from various sources. Some typical exemplary sources of vibration may include, for example but not limited to, vibrations due to the traversal across a gap between two adjacent commutator plates, vibrations due to other moving components in the rotatory device or other devices or components driven by or driving the rotatory source (e.g., blades or vanes of a fan, rotatory driving mechanism for a generator, etc.), or any other sources of vibration.

In some embodiments, the rotatory device includes an EMI (electromagnetic interference) suppression mechanism that is operatively connected to or is an inseparable part of the second end of a brush. In some embodiments, the EMI suppression mechanism comprises an arcuate, curved, or serpentine segment that bends in a direction away from the commutator plates. In some of these embodiments, the EMI suppression mechanism comprises a material with high resistivity. In some of these embodiments, the EMI suppression mechanism including a material of high resistivity is distributed in the area or vicinity around or near the commutation region, and the resistivity of the material for the EMI suppression mechanism is higher than that of at least the commutation region of a brush.

In some embodiments, the EMI suppression mechanism comprises an arcuate, curved, or serpentine segment that bends in a direction away from the commutator plates. In some embodiments, the rotatory device includes a filter circuitry. In some of these embodiments, the filter circuitry contains one or more capacitors and one or more interconnects. In one embodiment, the filter circuitry includes one or more grounded capacitors. In some of these embodiments, each commutator plate is electrically connected to at least two grounded capacitors, which are connected in parallel and are further connected to the ground.

In the aforementioned embodiments, the rotatory device is effectively protected from various noise (e.g., Gaussian noise, drift noise, shot noise, any combinations thereof, etc.) or electromagnetic interferences from various sources such that the frequency-based noise (e.g., various colors of noise) or non-frequency based noise (e.g., pops, crackles, snaps, etc.) may be suppressed or reduced. In one embodiment, the rotatory device or rotatory assembly does not include any ferrite bead, which comprises a passive electric component often used to suppress high or higher frequency noise in electronic circuits by dissipating high frequency currents in a ferrite ceramic. It shall be noted that unless otherwise specifically claimed or recited, a ferrite bead is used interchangeably with a block, a core, an EMI filter, or a choke, all of which comprise some passive electronic component to block high or higher frequency current in an electrical circuit, while allowing low or lower frequency or DC current to pass.

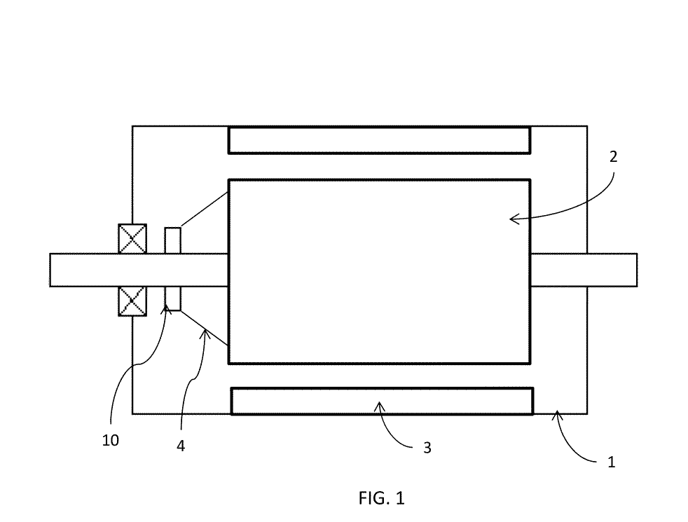

FIG. 1 illustrates a simplified schematic diagram of an exemplary rotatory device in some embodiments. More specifically, FIG. 1 illustrates a schematic representation of an rotatory device such as an electric motor or generator that includes a stator 1, a rotor 2, a commutator 10 having multiple commutator plates, a magnetic assembly 3 in the stator, and windings 4 in the rotor 2. During operation, the brushes contact the corresponding commutator plates in the commutator 10. As a practical example, when the rotatory device is electrically powered, a magnetic field is developed around the rotor 2. One side of the rotor 2 closer to, for example, the N-pole is repulsed away from the magnet assembly 3 and drawn toward the other side, causing the rotor 2 to rotate or spin.

When an electrical current passes through the windings 4 (e.g., a coil wound around a soft iron core), the magnetic field of the magnetic assembly 3 applies a torque on the winding 4 and causes a rotational effect on the windings 4, making the windings 4 rotate or spin. To make the rotatory device rotate or spin in a one direction, direct current commutators may be used to reverse the direction of the electrical current every half a cycle (e.g., in a two-pole motor) thus causing the rotatory device to continue to rotate in the same direction. On the other hand, if the shaft of the rotatory device is turned by an external force, the rotatory device may act like a generator and produce an Electromotive force (EMF).

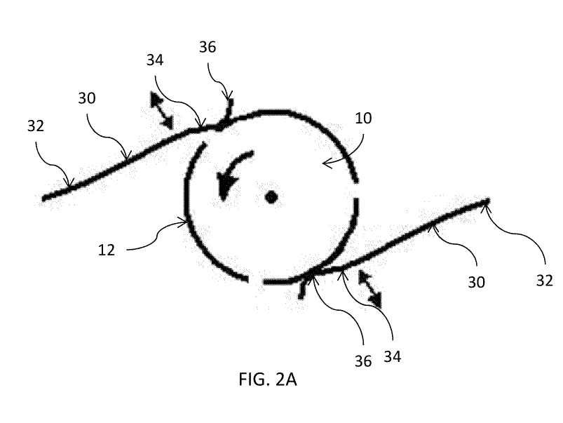

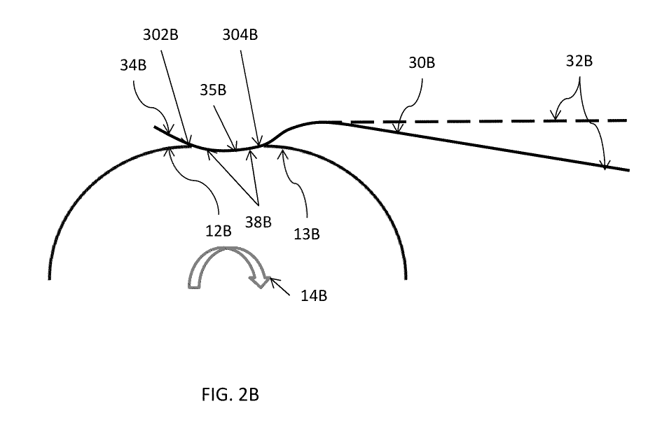

FIG. 2A illustrates a plan schematic view of interrelation between brushes and a commutator of an exemplary rotatory device at one point in time in some embodiments. More specifically, FIG. 2A illustrates a commutator 10 and two brushes 30 that are in contact with commutator 10. In the exemplary rotatory device illustrated in FIG. 2A, the commutator 10 includes multiple commutator plates 12 that are arranged in an angular manner along the outside diameter of the commutator 10. In some embodiments illustrated in FIG. 2A, In some of these embodiments, these multiple commutator plates may be arranged in an axis-symmetric manner with respect to the center axis of the commutator. In some of these embodiments, the commutator comprises multiple commutator plates, each having a three-dimensional shape having at least one convex surface.

In some embodiments, the commutator comprises multiple commutator plates, each having a section along the lengthwise direction of a substantially right or oblique cylindrical shape. In some of these embodiments, the “convex” surface or the substantially cylindrical surface may be used to contact the brushes to conduct electrical currents. It shall be noted that the term “substantially” or “substantial” such as in the “substantially cylindrical shape” is used herein to indicate that certain features, although designed or intended to be perfect (e.g., perfectly cylindrical), the fabrication or manufacturing tolerances, the slacks in various mating components or assemblies due to design tolerances or normal wear and tear, or any combinations thereof may nonetheless cause some deviations from this designed, perfect characteristic. Therefore, one of ordinary skill in the art will clearly understand that the term “substantially” or “substantial” is used here to incorporate at least such fabrication and manufacturing tolerances, the slacks in various mating components or assemblies, or any combinations thereof.

In these embodiments illustrated in FIG. 2A, two brushes 30 are respectively connected to the positive and the negative pole of a power source (e.g., a direct current source), and each brush comprises a first end 32 that may be connected to the power source (e.g., via a lead or a wire) and a second end 34 at least a portion of which contacts the commutator for commutation during the operation of the exemplary rotatory device. A brush 30 may comprise one or more features that may be made of one or more materials comprising a resilient material to withstand shock or loading without substantially permanent deformation or rupture, an elastic material to recover its original shape or size after deformation due to, for example, shock or loading, or any other materials whose deformations under loading is at least somewhat reversible such that the brush may maintain sufficient contact stress (e.g., stress due to the deformation of at least a portion of the brush 30) against the commutator plates 12 without generating an excessive amount of heat that exceeds a predetermined threshold due to poor electrical contacts.

In these embodiments, the brush 30 remains flexible although the brush does not necessarily restore to its original shape or profile once the loading is removed. In some embodiments, a brush 30 includes one or more finger elements that are used to make electrical contact with the commutator plates 12 with sufficiently contact stress (e.g., stress due to the deformation of at least a portion of the brush 30 or a finger element) or sufficiently low contact resistance such that the electrical contact between the finger elements and a commutator plate 12 does not generate an amount of heat that exceeds a predetermined amount. For example, the brush 30 or the commutator plates 12 may be designed or configured in such a way that the contact stress therebetween is at or exceeds the yield stress of the weaker (the component having lower yield stress) or the stronger (the component having higher yield stress). In some embodiments, the contact stress may be less than the yield stresses of both the brush 30 (or the finger element) and the commutator plate 12 so long as the heat generation due to higher contact resistance is acceptable or tolerable. The contact stress of a brush—commutator plate combination may be determined analytically, numerically, or by experimentation in some embodiments. In addition or in the alternative, the total number of fingers of a brush may be determined based at least in part upon one or more physical properties, one or more operational requirements including, for example but not limited to, the amount of electric current flowing through the brush, or any combinations thereof in some embodiments. For example, the total number of fingers of a brush may be determined by the maximum or permitted current density the fingers or the commutation plates are designed to carry by considering the maximum or permitted amount of electric current, the geometric configurations of the fingers and the commutator plates during commutation.

In some embodiments, the finger element of a brush 12 or a portion of the brush 30 itself includes a high resistivity element such that the brush does not cause short by electrically contacting more than one commutator plate with electrically conductive material when the brush is passing through a gap between two adjacent commutator plates 12 during operations of the rotatory device. In some of these embodiments, the finger element of a brush 30 or a portion of the brush 30 itself comprises a resilient, elastic, or flexible shape or material to maintain electrical contact with the commutator plates 12 such that that the brush 30 does not cause short even when the rotatory device, the commutator 10, or the finger element is subject to some vibrations from various sources. It shall be noted that a resistivity value of a material refer to the nominal value of electrical resistivity of that material at a certain temperature (e.g., 20° C. or 293 K), rather than actual resistivity values that may exhibit some variations due to variations in one or more properties of the material.

In these embodiments, vibrations cause changes in the electrical contact resistance and thus corresponding changes in, for example, heat generation, noise due to changes in electrical conductance, electronic noise, or electromagnetic interferences (collectively EMI). In some embodiments, the rotatory device illustrated in FIG. 2A includes an EMI (electromagnetic interference) suppression mechanism that is operatively connected to or is an inseparable part of the second end 34 of a brush 30. In the embodiments illustrated in FIG. 2A, the EMI suppression mechanism comprises a straight, an arcuate, a curved, or a serpentine segment 36 that bends in a direction away from the commutator plates 12. In some of these embodiments, the EMI suppression mechanism comprises one or more features that are made of one or more materials including a material having high resistivity.

In some of these embodiments, the EMI suppression mechanism including a material of high resistivity is distributed in the area or vicinity around or near the commutation region where the brush 30 or a portion thereof contacts the commutator plates 12, and the resistivity of the material for the EMI suppression mechanism is higher than that of the material of at least the commutation region of a brush 30. In some of these embodiments, the EMI suppression mechanism may be separately attached to the second end of a brush by, for example but not limited to, any appropriate processes for joining two components together including welding, mechanical means, brazing, spraying, powder coating, sintering, co-sintering, gluing, diffusion bonding, etc.

FIG. 2B illustrates more details about the plan schematic view of interrelation between brushes and a commutator of an exemplary rotatory device illustrated in FIG. 2A at another point in time in some embodiments. More specifically, FIG. 2B illustrates a brush 30B that is substantially similar to the brush 30 in FIG. 2A and comprises a first end 32B that may be connected to a power source and a second end 34B. In the embodiments illustrated in FIG. 2B, the brush 30B includes a curved, arcuate, or serpentine segment that curves away from the commutator plates 12B and 13B. The brush 30B includes a commutation region 35B that contacts the commutator plate (12B or 13B). At a specific moment or during a period of time during commutation, the commutator and hence the commutator plates 12B and 13B rotate or spin in a direction 13B where the brush 30B simultaneously contacts both commutator plates 12B at 302B and 13B at 304B.

In these embodiments, the area surrounding points 302B and 304B may include one or more features 38B made of a material comprising a high resistivity such that the simultaneous contact between the brush 30B and two commutator plates (12B and 13B) does not cause a short. The exact dimensions of the area surrounding points 302B and 304B or the exact dimensions of other portions of a rotatory device illustrated and described herein may be determined based at least in part upon one or more weighted or non-weighted factors including the designs of various components in the rotatory device (e.g., the geometric dimensions of the commutator plates 12B or 13B, the thickness or profile of the brush 30B, etc.), the available space in the rotatory device, the manufacturing process(es) for making various components of the rotatory device (e.g., the recommended bend radius for a particular material of a certain thickness, the selections of materials for various components in the rotatory device, operation requirements of the rotatory device (e.g., rotation speed(s), power input or output requirement, etc.), any combinations thereof, or any other factors that may affect the design of these designs.

Therefore, the segment including the first end 32B may have different profiles as 32B points to in FIG. 2B. In addition to preventing bridging two commutator plates (e.g., 12B and 13B). The high resistivity materials may reduce or suppress variations in electrical conductance, vibrations from various sources, or conductance changes due to vibrations from various sources (e.g., intermittent electrical contact or electrical contact with varying contact stresses, etc.), especially during the period of time when a brush about to complete commutation with respect to one commutator plate (e.g., 12B) and to initiate a new commutation with respect to another commutator plate (e.g., 13B) because such high resistivity materials in the brush 30B reduces or even eliminates electrical currents between the brush 30B and the corresponding commutator plate (e.g., 12B or 13B). The brush 30B also includes a commutation region 35B that includes a material comprising a low resistivity or is electrically conductive in order to contact the commutator plates to conduct electrical power through the brush 30B. In some embodiments where the segment including the commutation region 35B comprises an arcuate, curved, or serpentine shape the curvature of the segment or the curvature for the portion of the brush 30B between point 302B and point 304B may be designed or configured to have less than or equal to 20 times of the radius of a corresponding commutator plate (12B or 13B).

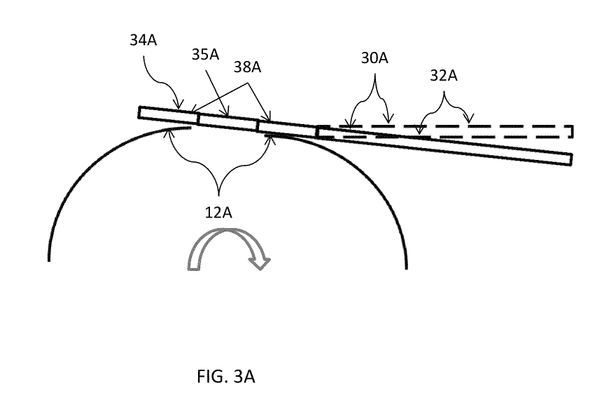

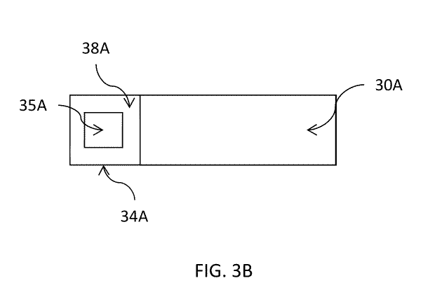

FIG. 3A illustrates a plan schematic view of interrelation between brushes and a commutator of an exemplary rotatory device at one point in time in some embodiments. More specifically, FIG. 3A illustrates a brush 30A contacting two commutator plates 12A while the commutator is rotating or spinning. The brush 30A includes a first end 32A that may be connected to the power source (e.g., via a lead or a wire) and a second end 34A at least a portion of which contacts the commutator plate(s) for commutation during the operation of an exemplary rotatory device. Moreover, in the embodiments illustrated in FIG. 3A, the second end 34A of the brush 30A or the portion of the brush 30A closer to the second end 34A may include a commutation region 35A that comprises an electrically conductive material and a contiguous region or multiple discrete regions 38A that comprise a material having a resistivity value higher than that of the material of the commutation region 35A.

In some embodiments, the contiguous region or multiple discrete regions 38A may serve as the EMI suppression mechanism that may be used to suppress or reduce electromagnetic interferences from various sources. In some embodiments, the geometry of the brush 30A itself may serve as an EMI suppression mechanism by using the resilient, elastic, or flexible characteristic of the brush 30A to ensure sufficient electrical contact between the brush 30A and the commutator plates 12A. In some embodiments, the resilient, elastic, or flexible characteristic of the brush 30A may further be leveraged to reduce or even eliminate negative effects of vibrations from various sources.

For example, the brushes 30A may be configured or designed to ensure sufficiently low contact resistance or sufficiently high contact stress such that vibrations to some certain magnitude may exert some reduced or even negligible levels of negative impacts on electrical conductance so as to reduce electromagnetic interferences due to variations in the electrical conductance. In some embodiments, the brush 30A may comprise a straight overall shape that is positioned at an angle relative to the commutator plates 12A. In some other embodiments, the brush 30A may comprise a shape that is bent at a certain angle at a certain location. It shall be noted that the actual values of various angles or locations described herein may be determined based at least in part upon one or more weighted or non-weighted factors including the designs of various components in the rotatory device (e.g., the geometric dimensions of the commutator plates 12A, the thickness or profile of the brush 30A, etc.), the available space in the rotatory device, the manufacturing process(es) for making various components of the rotatory device (e.g., the recommended bend radius for a particular material of a certain thickness, the selections of materials for various components in the rotatory device, operation requirements of the rotatory device (e.g., rotation speed(s), power input or output requirement, etc.), costs, or any combinations thereof, or any other factors that may affect the design of these designs.

FIG. 3B illustrates a plan schematic view of a brush of an exemplary rotatory device at one point in time in some embodiments. More specifically, FIG. 3B illustrates a brush 30A comprising a commutation region 35A that comprises an electrically conductive material and a contiguous region or multiple discrete regions 38A that comprise a material having a resistivity value higher than that of the material of the commutation region 35A. In FIG. 3B, the contiguous region or multiple discrete regions 38A appears to be surrounding the commutation region 35A. The region 38A having higher resistivity may be used to prevent two commutator plates (e.g., 12A in FIG. 3A) from bridging together. Nonetheless, the illustration of FIG. 3B is not intended to limit the scope of other implementations having different regions with higher resistivity materials while serving identical or substantially similar purposes.

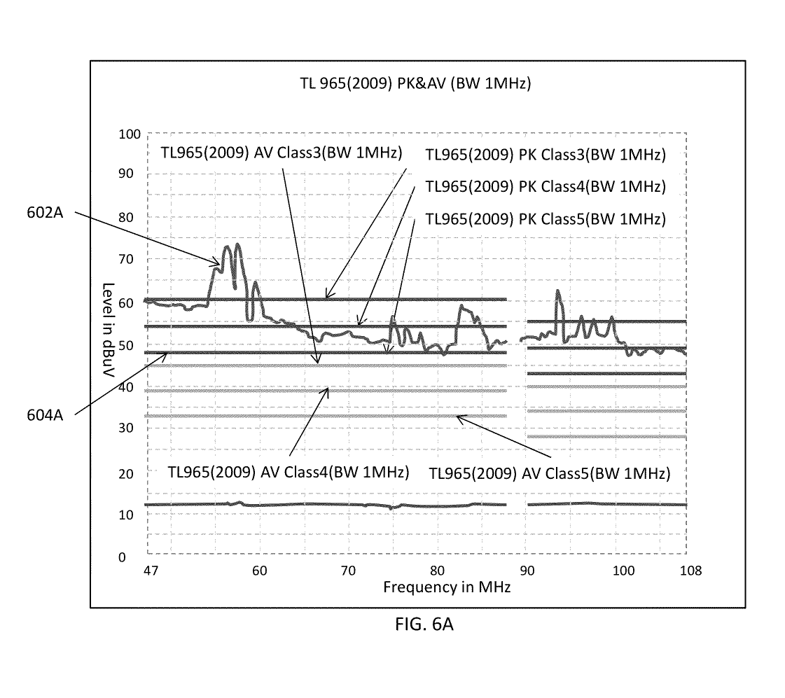

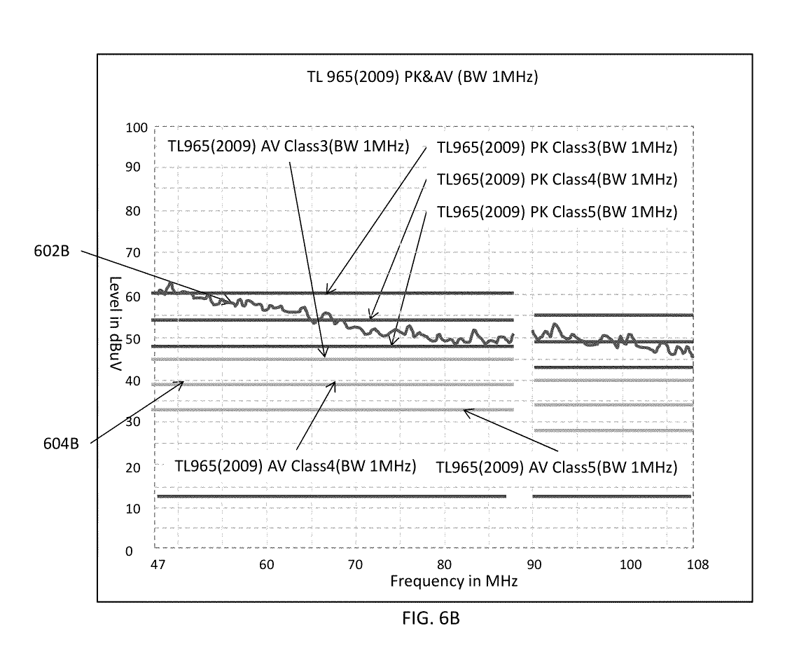

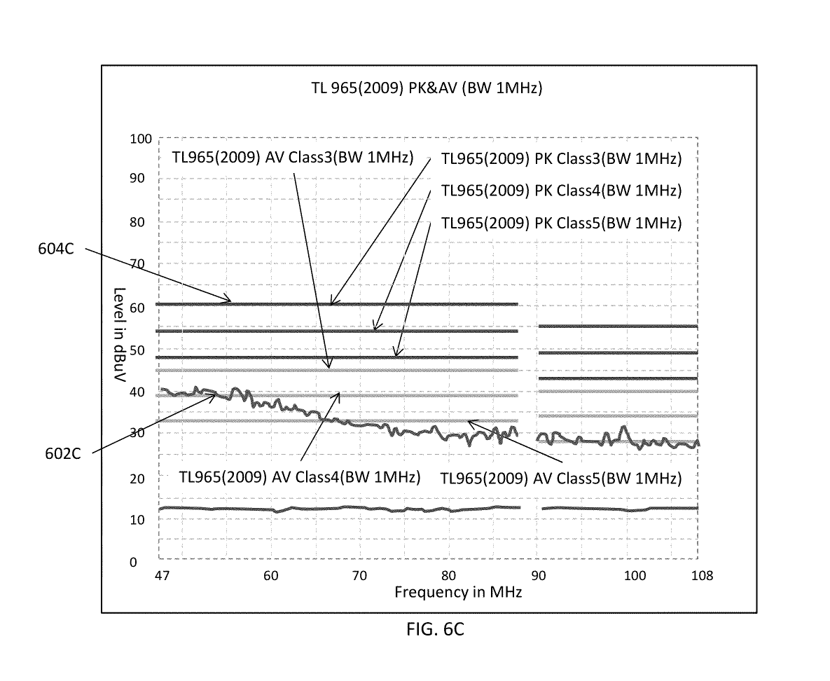

It shall also be noted that various elements in FIG. 3B are represented in quadrilateral shapes for the sole purpose of ease of illustration and explanations. Nonetheless, the use of quadrilateral shapes in FIG. 3B is not intended to limit the scope of various other embodiments having different geometric configurations of brushes. In some embodiments, one or more features that are described with reference to one or more of FIGS. 2A-B and 3A-B may be used to reduce, suppress, or filter out random electronic noise or random electromagnetic interferences. A noise level plot of an exemplary rotatory device including one or more features that are described with reference to one or more of FIGS. 2A-B and 3A-B is shown in FIG. 6B. It shall be noted that although reference numerals such as reference numeral 30 of FIG. 2A, reference numeral 30B of FIG. 2B, and reference numeral 30A of FIGS. 3A-B are described as “brush” or “brushes”, any one of these reference numerals may also be referred to as a feature that is separably attached to or inseparably attached to or formed on the body of a brush in some embodiments. For example, any one of the aforementioned reference numerals may comprise a finger element in the form of a strip of various geometries and may be inseparably or inseparably attached to the body of the brush in some embodiments.

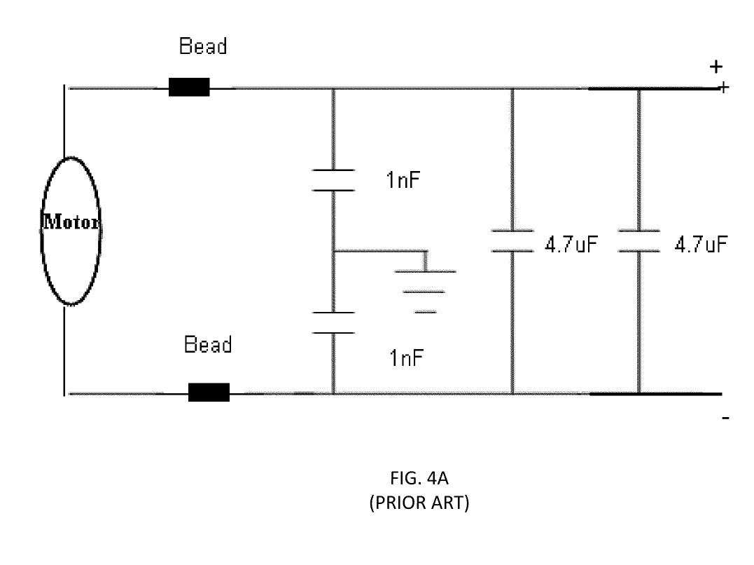

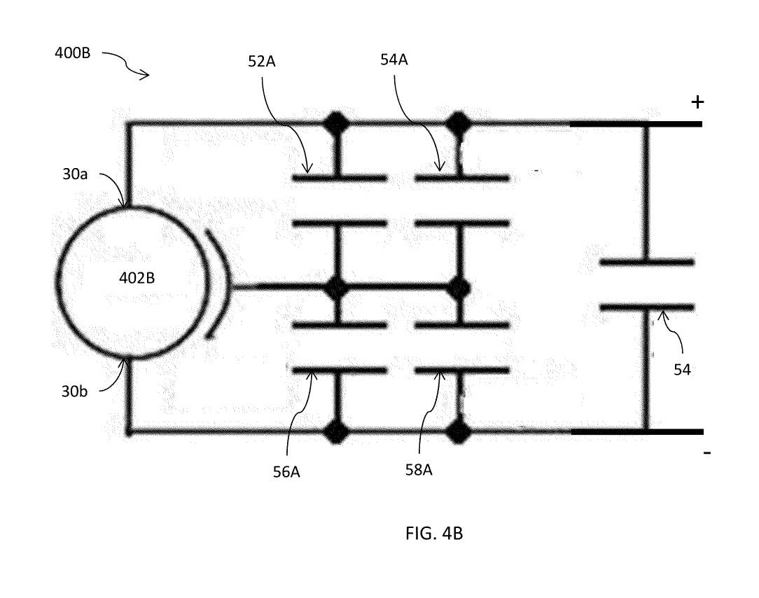

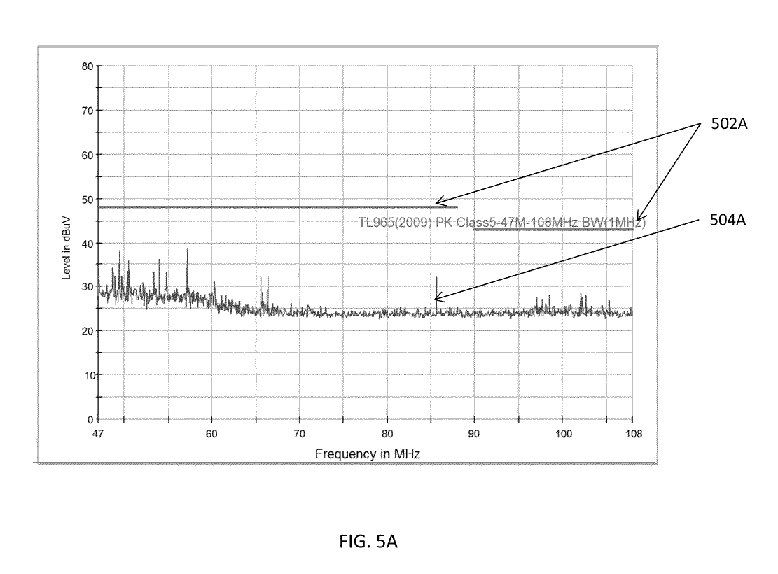

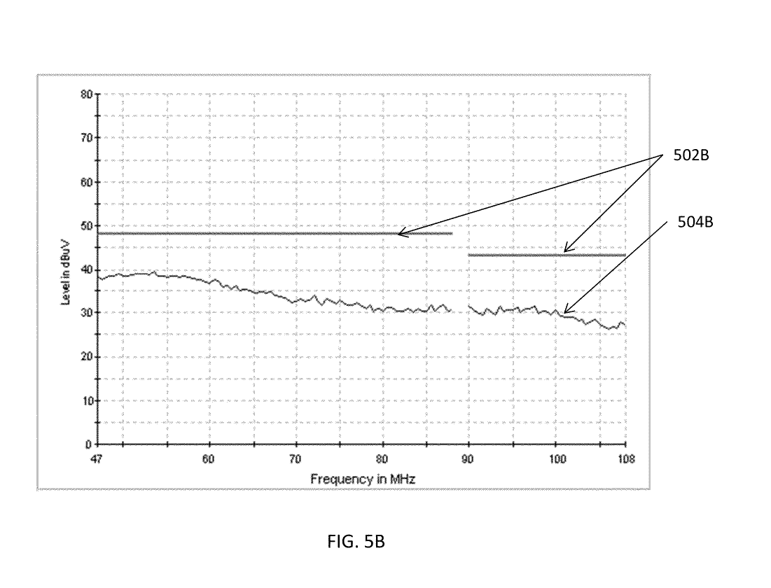

FIG. 4A illustrates a schematic of benchmark filter circuitry in some embodiments. More specifically, the benchmark filter circuitry includes two grounded 1 μF capacitor elements and two 4.7 μF capacitor elements connected in parallel to the motor. The benchmark filter circuitry also includes ferrite beads and may be found in many conventional motor or generator designs. Some exemplary performance characteristics of a rotatory device with the illustrated benchmark filter circuitry illustrated in FIG. 4A will be described in the following sections with reference to FIGS. 5A and 6A.

FIG. 4B illustrates a schematic of an exemplary filter circuitry 400B in some embodiments. More specifically, a rotatory device 402B including the exemplary filter circuitry may include the commutator 10 that is operatively connected to the brushes (30a and 30b, schematically) which are in turn operatively connected to a power source. The exemplary filter circuitry illustrated in FIG. 4B may include at least two capacitor elements 52A and 54A or 56A and 58A between each brush (30a or 30b) and ground. The at least two capacitor elements are connected in parallel to provide a bypass path to the ground at certain time points during commutation to suppress, reduce, or filter electronic noise or electromagnetic interferences. The at least two capacitor elements are in turn connected to ground.

In some embodiments including this exemplary filter circuitry, capacitor elements 52A and 56A respectively comprise capacitors with 1-100 nF capacitance, capacitor elements 54A and 58A are capacitors having 10-100 pF capacitance. Some embodiments may further optionally include a capacitor element 54 having 0.47-20 μF capacitance to further reduce, suppress, or filter electronic noise or electromagnetic interferences (e.g., differential-mode interferences). In some of these embodiments, capacitor element 54 comprises a capacitor having 8-12 μF capacitance. In some of these embodiments, capacitor elements 52A and 56A respectively comprise capacitors having 8-12 nF capacitance. In some embodiments, capacitor elements 54A and 58A respectively comprise capacitors having 65-70 pF capacitance.

In some embodiments, a capacitor element in a filter circuitry may be determined based at least in part upon the resonant frequency of the filter circuitry such that the filter circuitry exhibits a desired or required quality factor (Q factor). In some of these embodiments, the capacitor elements in a filter circuitry are determined in such a way that the filter circuitry may achieve resonance. Some of these embodiments may even include the capacitor elements to achieve resonance without using any inductors. It shall be noted that although the exemplary filter circuitry illustrated in FIG. 4B presents a passive filter circuitry, the illustration of a passive filter circuitry does not preclude the options of having an active filter circuitry with amplification (e.g., amplification with an operational amplifier) for rotatory devices described herein.

In some embodiments, the exemplary filter circuitry illustrated in FIG. 4B may be used to reduce or suppress the overall noise levels (e.g., a root mean square or RMS voltage, the noise standard deviation, etc.) of a rotatory device. In some embodiments, one or more features that are described with reference to FIG. 4B may be used to reduce or suppress the overall level of electronic noise or random electromagnetic interferences. A noise level plot of an exemplary rotatory device including one or more features that are described with reference to FIG. 4B is shown in FIG. 6C. It shall be noted that the exemplary rotatory device for which FIG. 6C is generated also includes one or more features that are described with reference to one or more of FIGS. 2A-B and 3A-B to reduce, suppress, or filter out random electronic noise or random electromagnetic interferences. It shall also be noted that the illustration and description of the exemplary filter circuitry herein does not preclude the use of other filters (e.g., a linear or nonlinear filter, an analog or digital filter, a high-pass filter, a low-pass filter, a band-pass filter, a band-reject filter, an all-pass filter, etc.)

It shall further be noted that in the embodiments illustrated in FIG. 4B, the exemplary filter circuitry is designed or configured without using any electronic chokes or beads (e.g., ferrite beads). A bead comprises a passive electronic component that is often used to suppress noise (e.g., high frequency noise) in electronic circuits. A choke comprises a passive electronic component (e.g., an inductor) for blocking or filtering higher-frequency alternating current (AC) in electrical circuits while allowing lower-frequency alternating or direct current to pass. One advantage of such an exemplary filter circuitry is that the resulting lower cost of the filter circuitry or the cost of the rotatory device including the exemplary filter circuitry due to the absence of any beads.

FIG. 5A illustrates a benchmark electronic noise profile with respect to frequencies of an exemplary rotatory device with the benchmark filter circuitry illustrated in FIG. 4A in some embodiments. FIG. 5A shows the standard or acceptable noise levels 502A and the noise level plot 504A with respect to frequencies of the benchmark filter circuitry. As FIG. 5A shows, the noise level plot 504A exhibits numerous random spikes of a magnitude about 5-15 dB μV, especially in the frequency range below 70 MHz.

FIG. 5B illustrates an improved electronic noise profile with respect to frequencies of an exemplary rotatory device in some embodiments. FIG. 5B shows the same standard or acceptable noise levels 502B while the noise level plot 504B with respect to frequencies exhibits a much smoother distribution with spikes of some small magnitudes. It shall be noted that the exemplary rotatory device for which FIG. 5B is generated is different from the exemplary rotatory device for which FIG. 5A is generated, and thus the overall noise level appears to be higher in FIG. 5B. Nonetheless, the overall higher noise level shown in FIG. 5B does not indicate that various embodiments of rotatory devices described herein produce higher level of noise.

More specifically, the exemplary rotatory device for which FIG. 5A is generated includes the brushes as shown in FIG. 2A and the filter circuitry as shown in FIG. 4A. The exemplary rotatory device for which FIG. 5B is generated includes the brushes as shown in FIG. 3A and the filter circuitry as shown in FIG. 4A. From FIGS. 5A-B, the noise performances of both rotatory devices are acceptable because both noise level plots fall below the standard or acceptable noise levels (502A and 502B respectively). In some embodiments including the EMI suppression mechanism, the noise performance may be further improved as illustrated in FIGS. 6A-C and described below.

FIGS. 6A-C illustrate electronic noise profiles with respect to frequencies (MHz) for one or more exemplary rotatory devices in some embodiments. More specifically, FIG. 6A illustrates a conventional rotatory device with a conventional filter circuitry. As it can be seen from FIG. 6A, the noise level plot 602A includes numerous random spikes of some substantial magnitudes and exceeds the standard or acceptable level 604A in one or more band of frequencies. FIGS. 6B-C illustrates the improved noise performances of rotatory devices with one or more features such as the brush design(s), the EMI suppression mechanism, or the filter circuitry described herein. For example, 602B of FIG. 6B illustrates substantial suppression or reduction of the random spikes as shown in 602A of FIG. 6A although FIG. 6B shows that the noise level still exceeds the standard or acceptable level 604B within a much narrower range of frequencies, and the overall noise level shown in 602B remains close to the overall noise level shown in 602A.

In some embodiments, the rotatory device for which FIG. 6B is generated includes one or more features described for the brushes in the preceding paragraphs but not the filter circuitry illustrated in FIG. 4B. FIG. 6C shows further improvement on the noise performance of rotatory devices including the brush designs, the EMI suppression mechanism, and the filter circuitry described above. More specifically, the noise level plot 602C in FIG. 6C not only shows the effective reduction, suppression, or filtering of the random spikes but also the reduction of the overall noise level by around 20 dB μV. The noise performance as shown in 602C thus meets the standard or acceptable noise levels 604C. In some embodiments, the rotatory device for which FIG. 6C is generated includes one or more features of the brushes described above with reference to FIGS. 2A-B and 3A-B as well as the filter circuitry described with reference to FIG. 4B.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A rotatory device for conversion between electrical energy and mechanical energy, comprising:
a commutator including multiple commutator plates; and
multiple brushes in sliding contact with at least some of the multiple commutator plates, wherein a brush of the multiple brushes includes:
a first segment comprising a commutation region having a first resistivity, and
a second segment comprising a first high resistivity feature having a second resistivity greater than the first resistivity.

2. The rotatory device of claim 1, further comprising a filter circuitry operatively coupled to the multiple brushes.

3. The rotatory device of claim 1, wherein the brush of the multiple brushes further comprises:
a third segment comprising a second feature adjacent to the commutation region of the first segment and remote from the second segment.

4. The rotatory device of claim 1, wherein:
a commutator plate of the multiple commutator plates comprises a commutation surface having a convex geometric shape in contact with at least a part of the commutation region of the brush of the multiple brushes during commutation, and
the brush of the multiple brushes further comprises a brush surface including the commutation region and having a geometric shape in contact with at least a part of a commutator plate of the multiple commutator plates during commutation, and
the geometric shape of the brush surface is configured based at least in part upon an electrical requirement of the rotatory device.

5. The rotatory device of claim 4, wherein the electrical requirement of the rotatory device includes a permitted electric current for the rotatory device such that the geometric shape is configured based at least in part upon a predetermined current density requirement of the brush surface and a predetermined permitted electric current for the rotatory device .

6. The rotatory device of claim 1, wherein the brush is in a predetermined level of contact with at least a part of a commutator plate of the multiple commutator plates within at least a period of time when energy in a first form is transformed to a second form during commutation.

7. The rotatory device of claim 1, wherein two or more commutator plates of the multiple commutator plates are configured to simultaneously contact only the first high resistivity feature of the second segment of the brush.

8. The rotatory device of claim 2, wherein the filter circuitry includes at least two capacitors that are operatively connected in parallel between the brush and electrical ground.

9. The rotatory device of claim 8, wherein the filter circuitry includes a first capacitor that is operatively connected to the multiple brushes.

10. The rotatory device of claim 8, wherein the filter circuitry consists of multiple capacitors and one or more interconnects.

11. The rotatory device of claim 1, wherein the first high resistivity feature of the second segment of the brush encloses the commutation region in the first segment in a cross-sectional profile of the first second segment and the second segment along a lengthwise direction.

12. The rotatory device of claim 1, the brush further comprising an electromagnetic interference suppression mechanism, wherein the electromagnetic interference suppression mechanism includes the first high resistivity feature on the second segment.

13. The rotatory device of claim 12, wherein the electromagnetic interference suppression mechanism further includes a geometric configuration that includes at least a portion on two opposing sides of the commutation region of the first segment of the brush.

14. A method for reducing electromagnetic interferences in a rotatory device, comprising:
identifying multiple brushes of the rotatory device;
providing power to the rotatory device to drive at least a commutator having multiple commutator plates in the rotatory device through contacts between the multiple brushes and multiple commutator plates of the commutator; and
effecting a predetermined level of contact to reduce at least a first part of electromagnetic interferences (EMI).

15. The method of reducing electromagnetic interferences of claim 14, wherein:
the portion of the brush that is used to reduce the at least the first part of electromagnetic interferences comprises an EMI suppression mechanism, and
the at least the first part of the electromagnetic interferences corresponds to random electromagnetic interferences.

16. The method of reducing electromagnetic interferences of claim 15, wherein the act of providing the power to the rotatory device comprises:
contacting only a single commutator plate of the multiple commutator plates with a flexible segment of the brush of the multiple brushes for commutation, wherein
the EMI suppression mechanism includes at least one of a flexible segment and a second segment having a first resistivity,
the second segment having the first resistivity contacts more than one commutator plate without bridging the more than one commutator plate.

17. The method of claim 14, further comprising:
reducing at least a second part of the electromagnetic interferences by using at least a filter circuitry.

18. The method of claim 17, wherein
the filter circuitry comprises at least two capacitors that are electrically connected in parallel to the brush and electrical ground, and
the second part of the electromagnetic interferences comprises an overall noise level.

19. The method of claim 18, wherein the filter circuitry comprises a first capacitor that is electrically connected to the multiple brushes.

20. The method of claim 13, wherein the act of reducing the at least the first part of electromagnetic interferences (EMI) comprises:
causing the at least the portion of the brush to contact a commutator plate of the multiple commutator plates to create a predetermined level of contact satisfying a first pre-predetermined level of contact.
